(19) United States
(12) Patent Application Publication
(10) Pub. No.: US 2026/0200797 A1
(43) Pub. Date: Jul. 16, 2026

(54) Gypsum Panel Containing a High Shear Water Repellent Additive

(71) Applicant: Gold Bond Building Products, LLC, Charlotte, NC (US)

(72) Inventors: Eli Stav, Charlotte, NC (US); Ju Dong, Charlotte, NC (US)

(21) Appl. No.: 19/448,406

(22) Filed: Jan. 14, 2026

Related U.S. Application Data
(60) Provisional application No. 63/744,913, filed on Jan. 14, 2025.

(51) Int. Cl. C04B 24/42; B28B 19/00; B32B 13/08; C04B 28/14; C04B 103/65; C04B 111/00; E04C 2/04

(52) U.S. Cl. CPC C04B 24/42; B28B 19/0092; B32B 13/08; C04B 28/14; E04C 2/043; B32B 2250/03; B32B 2250/40; B32B 2307/73; B32B 2607/00; C04B 2103/65; C04B 2111/0062

(57) ABSTRACT

The present disclosure is directed to a gypsum panel and a method of making such gypsum panel. The gypsum panel may include a water repellent composition comprising a water repellent additive. The water repellent additive may comprise a siloxane. Further, the water repellent additive may be sheared at a high shear rate, such as a shear rate of 8,500 rpm or more.

### RELATED APPLICATIONS

The present application is based upon and claims priority to U.S. Provisional Patent Application Ser. No. 63/744,913, having a filing date of Jan. 14, 2025, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. The mixture is cast and allowed to set by reaction of the calcined gypsum with the water. During the production process, a variety of additives can be incorporated into the gypsum panel to enhance the physical and mechanical properties of the gypsum panel.

Various additives have been utilized to enhance the water repellency properties of gypsum panels. Notably, bulk water or moisture that penetrates through a facing material may promote the growth of organisms, such as mold and mildew, which can lead to a number of health conditions. Additionally, water or moisture may deteriorate a gypsum panel. For instance, various components, such as the gypsum core, of a gypsum panel may begin to dissolve in a wet environment. Further, upon sufficient exposure to water or moisture, a gypsum core may crack due to freeze-thaw cycles and/or the facing material of a gypsum panel may separate from a gypsum core. It remains to be ascertained which compositions are particularly suitable for imparting water repellency characteristics and properties to a gypsum panel.

As a result, a need exists for providing a gypsum panel with improved water repellency properties.

### SUMMARY OF THE INVENTION

Aspects and advantages of the invention will be set forth in part in the following description, or may be obvious from the description, or may be learned through practice of the invention.

In accordance with one aspect of the present disclosure, a gypsum panel is disclosed. The gypsum panel comprises: a gypsum core, the gypsum core comprising gypsum; a water repellent composition, the water repellent composition comprising a water repellent additive, the water repellent additive comprising a siloxane, the water repellent additive having been subjected to a shear rate of about 5,000 rpm or more; and a first facing material and a second facing material; wherein the gypsum core has a concentration gradient of the water repellent additive over a portion of the thickness of the gypsum core.

In some implementations, the water repellent additive has been subjected to a shear rate of 7,500 rpm or more.

In some implementations, the water repellent additive has been subjected to a shear rate of 8,500 rpm or more.

In some implementations, the water repellent additive has been subjected to a shear rate of 10,000 rpm or more.

In some implementations, the water repellent additive has been subjected to a shear rate of 12,000 rpm or more.

In some implementations, the water repellent additive is present in the gypsum panel in an amount from about 0.001 lbs/MSF to about 50 lbs/MSF.

In some implementations, the concentration of the water repellent additive decreases across a portion of the thickness of the gypsum core beginning at the portion of the gypsum core adjacent at least one facing material.

In some implementations, the concentration of the water repellent additive decreases across a portion of the thickness of the gypsum core beginning at the portion of the gypsum core adjacent the first facing material.

In some implementations, the water repellent additive has a viscosity of about 1 cSt to about 100 cSt before being subjected to shearing.

In some implementations, the water repellent composition comprises water.

In some implementations, the gypsum panel comprises a first gypsum core layer and a second gypsum core layer, wherein the first gypsum core layer, the second gypsum core layer, or both comprise the water repellent composition.

In some implementations, the water repellent composition is applied to at least a portion of a surface of the first facing material, the second facing material, or both.

In some implementations, the water repellent additive has been subjected to a shear rate of 8,500 rpm or more; the water repellent additive is present in the gypsum panel in an amount from about 0.001 lbs/MSF to about 50 lbs/MSF; and the concentration of the water repellent additive decreases across a portion of the thickness of the gypsum core beginning at the portion of the gypsum core adjacent the first facing material.

In accordance with another aspect of the present disclosure, a gypsum panel is disclosed. The gypsum panel comprises: a gypsum core, the gypsum core comprising gypsum; a water repellent composition, the water repellent composition comprising a water repellent additive, the water repellent additive comprising a siloxane, the gypsum core having a two-hour absorption of water of about 5% or less when tested in accordance with ASTM C1396-17; and a first facing material and a second facing material; wherein the gypsum core has a concentration gradient of the water repellent additive over a portion of the thickness of the gypsum core.

In some implementations, the water repellent additive has been subjected to a shear rate of 8,500 rpm or more.

In some implementations, the gypsum panel comprises a first gypsum core layer and a second gypsum core layer, wherein the first gypsum core layer, the second gypsum core layer, or both comprise the water repellent composition.

In some implementations, the water repellent composition is applied to at least a portion of a surface of the first facing material, the second facing material, or both.

In some implementations, the water repellent additive has been subjected to a shear rate of 8,500 rpm or more; the water repellent additive is present in the gypsum panel in an amount from about 0.001 lbs/MSF to about 50 lbs/MSF; and the concentration of the water repellent additive decreases across a portion of the thickness of the gypsum core beginning at the portion of the gypsum core adjacent the first facing material.

In accordance with a further aspect of the present disclosure, a method of making a gypsum panel is disclosed. The method comprises: providing a first facing material; depositing a gypsum slurry comprising stucco and water onto the first facing material, the gypsum slurry forming a gypsum core; providing a second facing material on the gypsum slurry; and allowing the stucco to convert to calcium sulfate dihydrate; wherein the gypsum panel comprises a water repellent composition, the water repellent composition comprising a water repellent additive, the water repellent additive comprising a siloxane, the water repellent additive having been subjected to a shear rate of about 5,000 rpm or more.

In some implementations, the gypsum core has a two-hour absorption of water of about 5% or less when tested in accordance with ASTM C1396-17; the water repellent additive has been subjected to a shear rate of 8,500 rpm or more; the water repellent additive is present in the gypsum panel in an amount from about 0.001 lbs/MSF to about 50 lbs/MSF; and the concentration of the water repellent additive decreases across a portion of the thickness of the gypsum core beginning at the portion of the gypsum core adjacent the first facing material.

### BRIEF DESCRIPTION OF THE DRAWINGS

A full and enabling disclosure of the present invention, directed to one of ordinary skill in the art, is set forth in the specification, which makes reference to the appended figures, in which:

FIG. 1 illustrates a scatter plot and a logarithmic trendline of the Two-Hour Water Absorption vs. Shear Rate data of Example 1;

FIG. 2 illustrates a scatter plot and three exponential trendlines of the Two-Hour Water Absorption vs. Grams of Water Repellent Additive data of Example 2; and

FIG. 3 illustrates a scatter plot of the Two-Hour Water Absorption vs. Shear Rate data of Example 2.

Repeat use of reference characters in the present specification and drawings is intended to represent the same or analogous features or elements of the present invention.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present disclosure is directed to a gypsum panel and a method of making such gypsum panel. In particular, the gypsum panel can include a gypsum core, one or more water repellent compositions, and one or more facing materials. The gypsum core can include gypsum (i.e., calcium sulfate dihydrate), one or more water repellent compositions, and may include other optional additives. The present inventors have discovered that the gypsum panel disclosed herein can have various benefits due to the incorporation of a high shear water repellent additive in a water repellent composition. For instance, the gypsum core of the gypsum panel disclosed herein may have increased homogeneity of the high shear water repellent additive as compared to a gypsum core containing a water repellent additive that is not subjected to high shear. Notably, the increased homogeneity may enhance the water repellency of a gypsum panel. Additionally, a gypsum core comprising a high shear water repellent additive may have a decreased water absorption capacity (i.e., increased water repellency) as compared to a gypsum core comprising a water repellent additive that is not subjected to high shear.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

It should be understood that any concentration values disclosed herein may refer to mass concentration, molar concentration, number concentration, or volume concentration. It should be understood that, unless stated otherwise, any standard listed herein (e.g., ASTM) is the most recent version available as of the latest revision year.

It should be understood that, unless stated otherwise, all properties and characteristics of a siloxane disclosed herein may refer to the siloxane before and/or after shearing.

Notably, some aspects of the present disclosure may omit one or more of the features disclosed herein.

In general, the gypsum core may comprise calcium sulfate dihydrate. The gypsum used to make the gypsum core may be from a natural source, a synthetic source, and/or from reclaim and is thus not necessarily limited by the present invention. In general, the gypsum, in particular the calcium sulfate dihydrate, may be present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum may be present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

In general, a gypsum panel and/or any component (e.g., gypsum core) thereof may include a water repellent composition. Notably, a water repellent composition formed in accordance with the present disclosure may include one or more water repellent additives. A water repellent additive may be a siloxane. For instance, the water repellent additive may be methyl hydrogen siloxane (e.g., polymethylhydrogensiloxane). The siloxane may be in the form of a liquid and/or a solid.

The siloxane may be a polyorganosiloxane. Notably, silicon-bonded organic groups of the siloxane may contain monovalent hydrocarbon and/or monovalent halogenated hydrocarbon groups. Such monovalent groups may have from 1 to about 20 carbon atoms, preferably from 1 to 10 carbon atoms, and are exemplified by, but not limited to, alkyl (e.g., methyl, ethyl, propyl, pentyl, octyl, undecyl, and octadecyl); cycloalkyl (e.g., cyclohexyl); alkenyl (e.g., vinyl, allyl, butenyl, and hexenyl); aryl (e.g., phenyl, tolyl, xylyl, benzyl, and 2-phenylethyl); and halogenated hydrocarbon groups (e.g., 3,3,3-trifluoropropyl, 3-chloropropyl, and dichlorophenyl). In general, at least 30%, such as at least 40%, such as about 50% of the organic groups are methyl.

In general, a siloxane may have the following general formula (II):

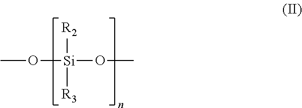

wherein,
n is an integer greater than 1; and
R₂ and R₃ are independently hydrogen, halogen, alkyl, cycloalkyl, aryl, heteroaryl, haloalkyl, haloaryl, alkoxy, carboxyalkyl, or alkenyl.

As indicated above, n is an integer greater than 1. In this regard, n may be 1 or more, such as 2 or more, such as 5 or more, such as 10 or more, such as 20 or more, such as 30 or more, such as 50 or more, such as 100 or more. In addition, n may be 500 or less, such as 400 or less, such as 300 or less, such as 200 or less, such as 150 or less, such as 125 or less, such as 100 or less, such as 80 or less, such as 60 or less, such as 50 or less, such as 40 or less, such as 30 or less.

As indicated above, R₂ and R₃ are independently hydrogen, halogen, alkyl, cycloalkyl, aryl, heteroaryl, haloalkyl, haloaryl, alkoxy, carboxyalkyl, or alkenyl. For instance, R₂ and R₃ may independently be a monovalent group typically containing from 1 to about 20 carbon atoms. The alkyl groups may be methyl, ethyl, propyl, pentyl, octyl, undecyl, octadecyl, etc. The alkoxy groups may be methoxy, ethoxy, propoxy, etc. The carboxyalkyl groups may be acetyl, etc. The cycloalkyl groups may be cyclohexyl, cyclooctyl, etc. The alkenyl groups may be vinyl, allyl, butenyl, hexenyl, etc. The aryl groups may be phenyl, tolyl, xylyl, benzyl, 2-phenylethyl, etc. The halogenated hydrocarbon groups may be 3,3,3-trifluoropropyl, 3-chloropropyl, dichlorophenyl, etc.

In one embodiment, at least one of R₂ and R₃ is hydrogen. In another embodiment, only one of R₂ and R₃ is hydrogen. In a further embodiment, at least one of R₂ and R₃ is alkyl. For instance, the alkyl may have 1 or more, such as 2 or more, such as 3 or more carbon atoms. The alkyl may have 20 or less, such as 16 or less, such as 12 or less, such as 10 or less, such as 8 or less, such as 6 or less, such as 4 or less, such as 2 or less carbon atoms. In one particular embodiment, only one of R₂ and R₃ is alkyl. In general, in one particular embodiment, the alkyl may be methyl.

Examples of one or more siloxanes (e.g., polyorganosiloxanes) that may be utilized as a water repellent additive include polydimethylsiloxane (“PDMS”), polymethylhydrogensiloxane, dimethyidiphenylpolysiloxane, dimethyl/methylphenylpolysiloxane, polymethylphenylsiloxane, methylphenyl/dimethylsiloxane, vinyldimethyl terminated polydimethylsiloxane, vinylmethyl/dimethylpolysiloxane, vinyldimethyl terminated vinylmethyl/dimethylpolysiloxane, divinylmethyl terminated polydimethylsiloxane, vinylphenylmethyl terminated polydimethylsiloxane, dimethylhydro terminated polydimethylsiloxane, methylhydro/dimethylpolysiloxane, methylhydro terminated methyloctylpolysiloxane, methylhydro/phenylmethyl polysiloxane, fluoro-modified polysiloxane, etc., or a mixture thereof. In one embodiment, a siloxane, such as the polyorganosiloxane, may be polydimethylsiloxane. In another embodiment, a siloxane, such as the polyorganosiloxane, may be polymethylhydrogensiloxane.

Notably, an organopolysiloxane may also contain one more pendant and/or terminal polar functional groups, such as hydroxyl, epoxy, carboxyl, amino, alkoxy, methacrylic, or mercapto groups, which impart some degree of hydrophilicity to the polymer. For example, an organopolysiloxane may contain at least one hydroxy group, and optionally an average of at least two silicon-bonded hydroxy groups (silanol groups) per molecule. Examples of such organopolysiloxanes may include, for instance, dihydroxypolydimethylsiloxane, hydroxy-trimethylsiloxypolydimethylsiloxane, etc. Alkoxy-modified organopolysiloxanes may also be employed, such as dimethoxypolydimethylsiloxane, methoxy-trimethylsiloxypolydimethylsiloxane, diethoxypolydimethylsiloxane, ethoxy-trimethylsiloxy-polydimethylsiloxane, etc. Notably, other suitable organopolysiloxanes are those modified with at least one amino functional group. Examples of such amino-functional polysiloxanes may include, for instance, diamino-functional polydimethylsiloxanes.

In some aspects, the siloxane may have a relatively high molecular weight. For example, the siloxane may have a molecular weight of about 500 g/mol or more, such as about 1,000 g/mol or more, such as about 1,500 g/mol or more, such as about 2,000 g/mol or more, such as about 3,000 g/mol or more, such as about 4,000 g/mol or more, such as about 5,000 g/mol or more, such as about 10,000 g/mol or more, such as about 25,000 g/mol or more. The siloxane may have a molecular weight of about 500,000 g/mol or less, such as about 400,000 g/mol or less, such as about 300,000 g/mol or less, such as about 200,000 g/mol or less, such as about 150,000 g/mol or less, such as about 100,000 g/mol or less, such as about 50,000 g/mol or less, such as about 20,000 g/mol or less, such as about 10,000 g/mol or less, such as about 5,000 g/mol or less, such as about 4,000 g/mol or less, such as about 3,000 g/mol or less.

In some aspects, the siloxane may have a viscosity of from about 1 cSt to about 1000 cSt before and/or after shearing, including all increments of 1 cSt therebetween. The siloxane may have a viscosity of about 1 cSt or more, such as about 10 cSt or more, such as about 25 cSt or more, such as about 50 cSt or more, such as about 100 cSt or more, such as about 250 cSt or more, such as about 500 cSt or more. The siloxane may have a viscosity of about 1000 cSt or less, such as about 500 cSt or less, such as about 250 cSt or less, such as about 100 cSt or less, such as about 50 cSt or less, such as about 25 cSt or less. The viscosity may be determined in accordance with ASTM D445. The viscosity may be measured using a Brookfield instrument or test, such as a Brookfield rotational viscometer.

In general, a water repellent composition may comprise a water repellent additive (e.g., a siloxane) in an amount from about 0 wt. % to about 100 wt. %, including all increments of 0.01 wt. % therebetween. In some aspects, a siloxane may be present in a water repellent composition in an amount of about 0 wt. % or more, such as about 10 wt. % or more, such as about 20 wt. % or more, such as about 30 wt. % or more, such as about 40 wt. % or more, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 100 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 40 wt. % or less, such as about 30 wt. % or less, such as about 20 wt. % or less, such as about 10 wt. % or less based on the weight of the water repellent composition.

A gypsum core or gypsum core layer incorporating a water repellent composition and/or a siloxane in accordance with the present disclosure may have a two-hour absorption of water of about 10% or less when tested in accordance with ASTM C1396-17, such as about 9% or less, such as about 8% or less, such as about 7% or less, such as about 6% or less, such as about 5% or less, such as about 4% or less. A gypsum core or gypsum core layer incorporating a water repellent composition and/or a siloxane in accordance with the present disclosure may have a two-hour absorption of water of about 2% or more when tested in accordance with ASTM C1396-17, such as about 4% or more, such as about 5% or more, such as about 6% or more, such as about 7% or more, such as about 8% or more.

The water repellent composition may include a wax. In some aspects, the water repellent composition may include a siloxane and a wax. The wax may be a natural wax, a synthetic wax, or a combination thereof. The wax may include animal waxes (e.g., beeswax, shlac wax, wool wax), vegetable waxes (e.g., bayberry wax, carnauba wax, castor wax, Jojoba oil wax, rice bran wax, soy wax), mineral waxes (e.g., montan wax, peat wax), petroleum waxes (e.g., paraffin wax, microcrystalline wax), synthetic waxes (e.g., polyolefin wax, polytetrafluoroethylene wax, stearamide wax, polymerized α-olefin wax, substituted amide waxes), or a combination thereof.

In some aspects, the wax includes a polyolefin wax. The polyolefin wax may be a homopolymer wax or a copolymer wax. The polyolefin wax may be a modified wax or an unmodified wax. The polyolefin wax may be a polyethylene wax, a polypropylene wax, or a mixture thereof. In some aspects, the wax includes at least a polyethylene wax, such as a homopolymer polyethylene wax, a copolymer polyethylene wax, or a mixture thereof. In some aspects, the wax includes a polypropylene wax, such as a homopolymer polypropylene wax, a copolymer polypropylene wax, or a mixture thereof.

The wax may be branched or linear. Also, the wax may have low crystallinity (e.g., less than 20%), moderate crystallinity (e.g., 20% to 40%), or high crystallinity (e.g., greater than 40%). The wax may have a weight average molecular weight of 500 g/mol or more, such as 1,000 g/mol or more, such as 1,500 g/mol or more, such as 2,000 g/mol or more, such as 3,000 g/mol or more, such as 4,000 g/mol or more, such as 5,000 g/mol or more. The wax may have a weight average molecular weight of 50,000 g/mol or less, such as 40,000 g/mol or less, such as 30,000 g/mol or less, such as 20,000 g/mol or less, such as 15,000 g/mol or less, such as 13,000 g/mol or less, such as 11,000 g/mol or less, such as 10,000 g/mol or less, such as 8,000 g/mol or less. The wax may have a polydispersity of from about 1.0 to about 4.0, more preferably from about 1.0 to about 2.5, and most preferably from about 1.0 to about 1.5.

In some aspects, the wax may have a certain viscosity at 25° C. when dispersed in water. For instance, the viscosity may be 5 cps or more, such as 10 cps or more, such as 25 cps or more, such as 30 cps or more, such as 40 cps or more, such as 50 cps or more, such as 100 cps or more, such as 250 cps or more, such as 300 cps or more, such as 500 cps or more, such as 1,000 cps or more. The viscosity may be 10,000 cps or less, such as 7,500 cps or less, such as 5,000 cps or less, such as 2,500 cps or less, such as 2,000 cps or less, such as 1,500 cps or less, such as 1,000 cps or less, such as 750 cps or less, such as 500 cps or less, such as 400 cps or less, such as 300 cps or less, such as 200 cps or less, such as 150 cps or less, such as 100 cps or less, such as 75 cps or less, such as 50 cps or less, such as 40 cps or less. Such viscosity may be measured using known techniques in the art. For instance, the viscosity may be measured using a Brookfield instrument or test, such as a Brookfield rotational viscometer.

The wax may also have a certain average particle size. For instance, the wax may have particles having an average particle size of 0.1 microns or more, such as 0.25 microns or more, such as 0.5 microns or more, such as 0.75 microns or more, such as 1 micron or more, such as 2 microns or more, such as 3 microns or more, such as 3.5 microns or more, such as 4 microns or more. The wax may have particles having an average particle size of 20 microns or less, such as 15 microns or less, such as 10 microns or less, such as 8 microns or less, such as 7 microns or less, such as 6 microns or less, such as 5 microns or less, such as 4.5 microns or less. All of the wax particles may have a particle size of 30 microns or less, such as 25 microns or less, such as 20 microns or less. The average particle size may be determined by a laser diffractometer, such as a Microtrac S3500.

A water repellent composition may comprise a wax in an amount from about 0 wt. % to about 100 wt. %, including all increments of 0.01 wt. % therebetween. In this respect, a wax may be present in a water repellent composition in an amount of about 0 wt. % or more, such as about 10 wt. % or more, such as about 20 wt. % or more, such as about 30 wt. % or more, such as about 40 wt. % or more, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 100 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 40 wt. % or less, such as about 30 wt. % or less, such as about 20 wt. % or less, such as about 10 wt. % or less based on the weight of the water repellent composition.

Generally, a gypsum panel formed in accordance with the present disclosure may have one or more water repellent compositions applied (e.g., sprayed) to and/or incorporated in any component of a gypsum panel (e.g., a gypsum core, a gypsum core layer, a facing material, a gypsum slurry) at any time of the process disclosed herein, including during, before, and/or after any of the process steps disclosed herein. Notably, one or more water repellent compositions may be incorporated in one or more gypsum slurries (e.g., a first gypsum slurry, a second gypsum slurry, a third gypsum slurry) and/or one or more gypsum core layers (e.g., a first gypsum core layer, a second gypsum core layer, a third gypsum core layer). Generally, a water repellent composition and/or any of the components thereof may be present between the first facing material and the gypsum slurry and/or gypsum core and/or may be present between the second facing material and the gypsum slurry and/or gypsum core. In this respect, a water repellent composition and/or any of the components thereof may be present at the interface of a facing material and a gypsum slurry and/or gypsum core. In general, a water repellent composition may be applied by spraying, brushing, curtain coating, and/or roll coating.

Notably, a water repellent composition applied to and/or incorporated in any component of a gypsum panel may be the same as or different than a water repellent composition applied to and/or incorporated in a different component of a gypsum panel. For instance, a water repellent composition incorporated in a first gypsum core layer may be the same as or different than a water repellent composition incorporated in a third gypsum core layer.

A water repellent composition may be incorporated in and/or applied to one or more facing materials (e.g., first facing material, second facing material). Generally, the method of application of the water repellent composition is not limited by the present disclosure and may include any method of application known in the art. Notably, the water repellent composition may be incorporated in and/or applied to the first facing material, the gypsum slurry, the second facing material, or a combination thereof. In some aspects, a water repellent composition may be incorporated in and/or applied to at least a portion of a surface of a first facing material and/or at least a portion of a surface of a second facing material that is adjacent to the gypsum slurry and/or gypsum core (i.e., the gypsum slurry and/or gypsum core facing surface of the first facing material, the gypsum slurry and/or gypsum core facing surface of the second facing material) before the gypsum slurry is deposited, provided, or contacted with the first facing material and/or before the second facing material is provided on or contacted with the gypsum slurry respectively. In some aspects, a water repellent composition may be incorporated in and/or applied to the gypsum slurry before the second facing material is provided on or contacted with the gypsum slurry. In this respect, the water repellent composition may be incorporated in and/or applied to at least a portion of the gypsum slurry adjacent the second facing material before the second facing material is provided on or contacted with the gypsum slurry. Additionally, in some aspects, the water repellent composition may be incorporated in and/or applied to the gypsum slurry before the second facing material is provided on or contacted with the gypsum slurry and may be incorporated in and/or applied to at least a portion of the surface of the second facing material that is adjacent the gypsum slurry (i.e., the gypsum slurry facing surface of the second facing material) before the second facing material is provided on or contacted with the gypsum slurry.

As previously disclosed herein, the water repellent composition may be applied to one or more facing materials on a surface or side of a facing material (e.g., first facing material, second facing material) adjacent to a gypsum slurry and/or gypsum core. In some aspects, the water repellent composition may be applied to one or more facing materials on a surface or side of a facing material (e.g., first facing material, second facing material) opposite a gypsum slurry and/or gypsum core. In this respect, the water repellent composition may be applied to one or more facing materials on the outward facing surface of one or more facing materials.

A water repellent composition may be incorporated in and/or applied to one or more facing materials (e.g., first facing material, second facing material) during the manufacturing process of the gypsum panel and/or in an offline process. When incorporated and/or applied in an offline process, the water repellent composition may be applied to a facing material (e.g., first facing material, second facing material) before the facing material is utilized in the manufacturing process of the gypsum panel.

Generally, a water repellent additive may undergo shearing in a shear mixer, such as a Quadro® Liquids high shear mixer, pin mixer, or an Axiflow® high shear mixer, at any time of the process disclosed herein, including during, before, and/or after any of the process steps disclosed herein. A shear mixer may combine a liquid (e.g., one or more surfactants, one or more dispersants, one or more siloxanes, one or more retarders, one or more alcohols, and/or water) with a water repellent additive. Notably, the one or more surfactants, one or more dispersants, one or more retarders, and/or one or more alcohols may be any of the respective surfactants, dispersants, retarders, and/or alcohols disclosed herein. The combination of a liquid and a water repellent additive and/or any components thereof in a shear mixer may form a dispersion or an emulsion. As used herein, the term “dispersion” refers to a liquid having solid particles dispersed therein. In some aspects, a water repellent additive and a liquid may be mixed or combined prior to being mixed in a shear mixer. In this respect, a water repellent additive may undergo one or more mixing processes. Notably, a shear mixer may continuously mix a liquid with a water repellent additive. After the shear mixer has mixed a liquid with a water repellent additive, the resulting water repellent composition, which may be in the form of a dispersion or an emulsion, may be applied (e.g., sprayed) to and/or incorporated in a facing material and/or a gypsum slurry.

The water repellent composition may be applied and/or incorporated as a dry application, a wet application, or a combination thereof. As used herein, a “dry application” of a water repellent composition refers to the application and/or incorporation of a water repellent composition that does not comprise a liquid. As used herein, a “wet application” of a water repellent composition refers to the application and/or incorporation of a water repellent composition that comprises a liquid (e.g., a dispersant).

Notably, the inventors of the present disclosure have discovered that shearing a water repellent additive (e.g., a siloxane) may enhance the water repellency of a gypsum panel and/or may decrease the amount of siloxane used to form a water repellent gypsum panel. Further, the inventors of the present disclosure have discovered that shearing a water repellent additive may increase the homogeneity of a water repellent additive in a gypsum core, which may increase the water repellency and durability of a gypsum panel. Additionally, subjecting a water repellent additive to high shear may result in smaller droplets of the water repellent additive dispersed in water, such as the water of the gypsum slurry or the water repellent composition. The smaller droplets of the water repellent additive may have a higher surface area and may provide a better coating of the gypsum of the gypsum core, which may lead to a lower water absorption of the gypsum core.

In some aspects, the water repellent composition and/or water repellent additive may be sheared at a shear rate of from about 5000 rpm to about 22000 rpm, including all increments of 1 rpm therebetween. A water repellent composition and/or a water repellent additive may be sheared at a shear rate of about 5000 rpm or more, such as about 5500 rpm or more, such as about 6000 rpm or more, such as about 6500 rpm or more, such as about 7000 rpm or more, such as about 7500 rpm or more, such as about 8000 rpm or more, such as about 8500 rpm or more, such as about 9000 rpm or more, such as about 9500 rpm or more, such as about 10000 rpm or more, such as about 11000 rpm or more, such as about 12000 rpm or more, such as about 13000 rpm or more, such as about 14000 rpm or more, such as about 15000 rpm or more, such as about 18000 rpm or more. A water repellent composition and/or a water repellent additive may be sheared at a shear rate of about 22000 rpm or less, such as about 20000 rpm or less, such as about 18000 rpm or less, such as about 15000 rpm or less, such as about 14000 rpm or less, such as about 13000 rpm or less, such as about 12000 rpm or less, such as about 11000 rpm or less, such as about 10000 rpm or less, such as about 9500 rpm or less, such as about 9000 rpm or less, such as about 8500 rpm or less, such as about 8000 rpm or less, such as about 7500 rpm or less, such as about 7000 rpm or less, such as about 6500 rpm or less, such as about 6000 rpm or less, such as about 5500 rpm or less.

A water repellent composition and/or a water repellent additive may be milled (e.g., ball-milled). Generally, a water repellent composition and/or a water repellent additive may be milled before, after, and/or during any of the process steps disclosed herein. For instance, a water repellent composition and/or a water repellent additive may be milled before being subjected to shearing. Notably, a water repellent composition may be formed by milling a mixture comprising one or more high shear water repellent additives and a liquid (e.g., water). As used herein, “milled” is synonymous with “ground”. The milling of a water repellent additive may decrease the average particle size of the water repellent additive. It should be understood that any of the components of the water repellent composition may be milled together or may be milled separately. When milled separately, the components of the water repellent composition may be combined or mixed before being applied to and/or incorporated in any component of a gypsum panel.

As previously disclosed, a water repellent composition and/or a water repellent additive may be ball-milled. However, it should be understood that a water repellent composition and/or a water repellent additive may be milled by other equipment, such as, for instance, an attritor, a vibration mill, an impact mill, a planetary ball mill, a jet mill, and the like.

In some aspects, a surface of a facing material (e.g., first facing material, second facing material) adjacent to a gypsum slurry and/or gypsum core may include a water repellent composition and/or a water repellent additive applied to and/or present on at least a portion of the surface of the facing material adjacent to a gypsum slurry and/or gypsum core. For instance, a water repellent composition and/or a water repellent additive may be applied to and/or be present on the surface of a facing material adjacent to a gypsum slurry and/or gypsum core in an amount of about 1% or more of the surface area of the surface of the facing material, such as in an amount of about 1% or more, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less of the surface area of the surface of the facing material.

In some aspects, the application of a water repellent composition and/or a water repellent additive may result in the penetration and/or embedment of a water repellent composition and/or a water repellent additive in one or more of the facing materials (e.g., first facing material, second facing material). Notably, the penetration and/or embedment of a water repellent composition and/or a water repellent additive may result in improved water repellency characteristics and properties. Generally, if the water repellent composition is applied via spraying, the intensity and/or angle of the spraying and the distance of the spraying mechanism to the facing material may affect the depth of penetration of the water repellent composition and/or any components (e.g., a water repellent additive) thereof.

A water repellent composition and/or a water repellent additive may penetrate at least a portion of the thickness of a respective facing material (e.g., first facing material, second facing material). Notably, the water repellent composition and/or a water repellent additive may penetrate a respective facing material (e.g., first facing material, second facing material) by about 0% to about 100% of the thickness of the respective facing material, such as about 0% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less.

Generally, when a water repellent composition and/or a water repellent additive is applied to a facing material, the longer the water repellent composition and/or the water repellent additive is in fluid contact with a facing material, the deeper the penetration of the water repellent composition and/or the water repellent additive. Notably, a water repellent composition and/or a water repellent additive may be in fluid contact with a facing material for a period of about 1 second to about 30 seconds, including all increments of 1 second therebetween. For instance, a water repellent composition and/or a water repellent additive may be in fluid contact with a facing material for about 1 second or more, such as about 5 seconds or more, such as about 10 seconds or more, such as about 15 seconds or more, such as about 20 seconds or more, such as about 25 seconds or more, such as about 30 seconds or less, such as about 25 seconds or less, such as about 20 seconds or less, such as about 15 seconds or less, such as about 10 seconds or less, such as about 5 seconds or less. In this respect, a water repellent composition and/or a water repellent additive may be in fluid contact with a facing material for a period of about 1 second to about 30 seconds, including all increments of 1 second therebetween, until a gypsum slurry contacts or is provided on a respective facing material.

A water repellent composition and/or a water repellent additive may be applied to and/or present in the gypsum panel in an amount of 0.001 lbs/MSF to about 25 lbs/MSF, including all increments of 0.001 lbs/MSF therebetween. For instance, a water repellent composition and/or a water repellent additive may be applied to and/or present in the gypsum panel in an amount of 0.001 lbs/MSF or more, such as 0.01 lbs/MSF or more, such as 0.05 lbs/MSF or more, such as 0.1 lb/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 10 lbs/MSF or more, such as 15 lbs/MSF or more. A water repellent composition and/or a water repellent additive may be applied to and/or present in the gypsum panel in an amount of 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

A water repellent composition and/or a water repellent additive may be applied to and/or present in a gypsum slurry or a gypsum panel and/or any component thereof in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more, such as 5 wt. % or more, such as 8 wt. % or more. A water repellent composition and/or a water repellent additive may be applied to and/or present in a gypsum slurry or a gypsum panel and/or any component thereof in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.30 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer.

A water repellent composition may comprise a liquid (e.g., one or more surfactants, one or more dispersants, one or more retarders, one or more alcohols, and/or water). A liquid may be present in a water repellent composition in an amount from about 0 wt. % to about 99.99 wt. %, including all increments of 0.01 wt. % therebetween. In this respect, a liquid (e.g., one or more surfactants, one or more dispersants, one or more retarders, one or more alcohols, and/or water) may be present in a water repellent composition in an amount of about 0 wt. % or more, such as about 10 wt. % or more, such as about 20 wt. % or more, such as about 30 wt. % or more, such as about 40 wt. % or more, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 99.99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 40 wt. % or less, such as about 30 wt. % or less, such as about 20 wt. % or less, such as about 10 wt. % or less based on the weight of the water repellent composition.

A water repellent composition and/or a water repellent additive may have a particular average particle size. For instance, a water repellent composition and/or a water repellent additive may have an average particle size of 500 microns or less, such as 400 microns or less, such as 300 microns or less, such as 200 microns or less, such as 150 microns or less, such as 100 microns or less, such as 80 microns or less, such as 75 microns or less, such as 50 microns or less, such as 40 microns or less, such as 25 microns or less, such as 20 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. A water repellent composition and/or a water repellent additive may have an average particle size of 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 25 microns or more, such as 40 microns or more, such as 50 microns or more, such as 75 microns or more, such as 80 microns or more, such as 100 microns or more, such as 200 microns or more, such as 300 microns or more, such as 400 microns or more. Furthermore, in one aspect, the aforementioned values may refer to a median particle size of the water repellent composition and/or the water repellent additive. In this respect, the water repellent composition and/or the water repellent additive may have a D₁₀, D₅₀, D₉₀, and/or D₉₇ of any of the values previously disclosed, including any incremental values therebetween. Notably, a water repellent composition and/or a water repellent additive may be milled and/or sheared to have a median particle size and/or average particle size from 5 nanometers to 500 microns, including all increments of 1 nanometer therebetween. Notably, in one aspect, the aforementioned values may refer to the agglomerate size of the water repellent composition and/or the water repellent additive. In this respect, the aforementioned values may refer to the combined average and/or combined median size of the agglomerates (i.e., particle agglomerates) and the individual particles of the water repellent composition and/or the water repellent additive. For instance, if a water repellent composition contains 30 wt. % agglomerates and 70 wt. % individual particles, all of the sizes of the agglomerates and the individual particles may be analyzed to determine an average and/or median of the combined agglomerates and individual particles. Notably, the average and/or median particle size may be determined by a laser diffractometer, such as a Microtrac S3500. The average and/or median particle size may be determined by dynamic image analysis, static image analysis, and/or dynamic light scattering. The average and/or median particle size may be determined via sieving.

The water repellent additive may be heterogeneously or nonuniformly dispersed in a gypsum core of a gypsum panel. In some aspects, the concentration of the water repellent additive may be such that a concentration gradient of the water repellent additive is formed in a gypsum core of a gypsum panel. It should be understood that the concentration may refer to mass concentration, molar concentration, number concentration, or volume concentration.

Notably, methods to determine the concentration of a water repellent additive at various sections or portions of a gypsum panel (e.g., center of the thickness of the gypsum core) are known to those skilled in the art. For instance, a sample from a section of a portion of a panel may be subjected to Nuclear Magnetic Resonance (NMR) Spectroscopy, X-Ray Fluorescence (XRF) Spectroscopy, or Fourier Transform Infrared (FTIR) Spectroscopy. The concentration of a water repellent additive at the interface of a gypsum core and a facing material may be determined by separating the facing material from the gypsum core, scraping at least a portion of the residual gypsum from the facing material, and performing one of the aforementioned methods to determine the concentration of water repellent additive at the interface of a gypsum core and a facing material.

In some aspects, the concentration gradient may be such that the concentration of the water repellent additive increases or decreases over a portion of the thickness, such as a thickness disclosed herein, of a gypsum core of a gypsum panel. In one aspect, a gypsum core of a gypsum panel may have a higher concentration of the water repellent additive in the portion of a gypsum core adjacent to the first facing material (e.g., the first gypsum core layer) with the concentration of the water repellent additive decreasing across a dimension (e.g., the thickness) of the gypsum core. In some aspects, the concentration of the water repellent additive in a gypsum core of a gypsum panel may decrease across a thickness of a gypsum core beginning at the portion of a gypsum core adjacent the first facing material and ending at the portion of the gypsum core adjacent the second facing material or ending at the center of the thickness of the gypsum core. It should be understood that the center of the thickness of a gypsum core of a gypsum panel is parallel to one or more respective facing materials and may be a plane that extends the length and width of the gypsum core.

In some aspects, a gypsum core of a gypsum panel may have a higher concentration of the water repellent additive in the portion of the gypsum core adjacent to the second facing material (e.g., a third gypsum core layer or second gypsum core layer) with the concentration of the water repellent additive decreasing across a dimension (e.g., the thickness) of the gypsum core. In some aspects, the concentration of a water repellent additive in a gypsum core of a gypsum panel may decrease across the thickness of the gypsum core beginning at the portion of the gypsum core adjacent the second facing material and ending at the portion of the gypsum core adjacent the first facing material or ending at the center of the thickness of the gypsum core.

In some aspects, a gypsum core (e.g., set gypsum core) of a gypsum panel formed in accordance with the present disclosure may have a higher concentration of the water repellent additive in the portion of the gypsum core adjacent to the first facing material as compared to the concentration of the water repellent additive in the portion of the gypsum core adjacent to the second facing material. In this respect, the concentration of the water repellent additive in the portion of the gypsum core adjacent to the first facing material may be higher than the concentration of the water repellent additive in the portion of the gypsum core adjacent to the second facing material. As used herein, a “set gypsum core” refers to the gypsum core after the drying process of the gypsum panel, which may include drying the gypsum panel in a heating or drying device (e.g., kiln). In another aspect, a gypsum core (e.g., set gypsum core) of a gypsum panel formed in accordance with the present disclosure may have a higher concentration of the water repellent additive in the portion of the gypsum core adjacent to the second facing material as compared to the concentration of the water repellent additive in the portion of the gypsum core adjacent to the first facing material. In this respect, the concentration of the water repellent additive in the portion of the gypsum core adjacent to the second facing material may be higher than the concentration of the water repellent additive in the portion of the gypsum core adjacent to the first facing material.

In some aspects, the concentration of the water repellent additive in the gypsum core (e.g., set gypsum core) of a gypsum panel may be higher in the portions of the gypsum core adjacent to the respective facing materials. For instance, the concentration of the water repellent additive in the gypsum core may be higher in the portions of the gypsum core adjacent the first facing material and the second facing material, as compared to the center of the thickness of the gypsum core. In some aspects, a gypsum core formed in accordance with the present disclosure may have a higher concentration of the water repellent additive adjacent to the first facing material and the second facing material with the concentration of the water repellent additive decreasing toward the center of the thickness of the gypsum core beginning at the portions of the gypsum core adjacent the first facing material and second facing material respectively.

Notably, in some aspects, the three highest concentrations of the water repellent additive in a gypsum core (e.g., set gypsum core) of a gypsum panel may be at the portion of the gypsum core adjacent the first facing material, at the center of the thickness of the gypsum core, and at the portion of the gypsum core adjacent the second facing material respectively. In this respect, the area of a gypsum core between the portion of the gypsum core adjacent the first facing material and the center of the thickness of the gypsum core may have a reduced concentration of the water repellent additive compared to the concentration of the water repellent additive in the portion of the gypsum core adjacent the first facing material and the center of the thickness of the gypsum core. Further, the area of a gypsum core between the portion of the gypsum core adjacent the second facing material and the center of the thickness of the gypsum core may have a reduced concentration of the water repellent additive compared to the concentration of the water repellent additive in the portion of the gypsum core adjacent the second facing material and the center of the thickness of the gypsum core.

Notably, it should be understood that a portion of a gypsum core may refer to a portion of a thickness of a gypsum core, such as 1/32 inches or more, such as 1/16 inches or more, such as 1/12 inches or more, such as ⅛ inches or more, such as ¼ inches or more. In this respect, in some aspects, a portion of a gypsum core adjacent to a facing material may be 1/12 inches or more. It should be understood that a portion of a gypsum core may refer to a portion of a thickness of a gypsum core, such as ½ inches or less, such as ¼ inches or less, such as ⅛ inches or less, such as 1/12 inches or less, such as 1/16 inches or less. In this respect, in some aspects, a portion of a gypsum core adjacent to a facing material may be ½ inches or less.

It should also be understood that a portion of a gypsum core of a gypsum panel adjacent to a facing material may refer to the portion of a gypsum core at the interface of the gypsum core and a facing material.

Notably, the portion of a gypsum core of a gypsum panel adjacent to a facing material may be parallel to one or more respective facing materials and may be a plane that extends the length and width of the gypsum core.

Further, it should be understood that the portion of a gypsum core of a gypsum panel adjacent to the first facing material may be referred to as the first gypsum core layer. Additionally, when a gypsum core of a gypsum panel includes two gypsum core layers, the portion of the gypsum core adjacent to the second facing material may be referred to as the second gypsum core layer. Further, when a gypsum core of a gypsum panel includes three gypsum core layers, the portion of the gypsum core adjacent to the second facing material may be referred to as the third gypsum core layer.

In some aspects, the ratio (e.g., mass ratio) of the concentration of the water repellent additive at the interface of the gypsum core and a facing material (e.g., the first facing material, the second facing material) to the concentration of the water repellent additive at the center of the thickness of the gypsum core may be from about 20:1 to about 1:20, including all incremental ratios therebetween. The ratio of the concentration of the water repellent additive at the interface of the gypsum core and a facing material (e.g., the first facing material, the second facing material) to the concentration of the water repellent additive at the center of the thickness of the gypsum core may be about 20:1 or less, such as about 15:1 or less, such as about 10:1 or less, such as about 5:1 or less, such as about 1:1 or less, such as about 1:5 or less, such as about 1:10 or less, such as about 1:15 or less. The ratio of the concentration of the water repellent additive at the interface of the gypsum core and a facing material to the concentration of the water repellent additive at the center of the thickness of the gypsum core may be about 1:20 or more, such as about 1:15 or more, such as about 1:10 or more, such as about 1:5 or more, such as about 1:1 or more, such as about 1.2:1 or more, such as about 1.5:1 or more, such as about 1.8:1 or more, such as about 2:1 or more, such as about 5:1 or more, such as about 10:1 or more, such as about 15:1 or

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellents (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer.

In some aspects, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In general, the first facing material and the second facing material may be the same type of material. Alternatively, the first facing material may be one type of material while the second facing material may be a different type of material. In one aspect, the first facing material and the second facing material may comprise the same binder (e.g., a polymeric binder). In another aspect, the first facing material and the second facing material may comprise a different binder. In an additional aspect, the first facing material and/or the second facing material may not comprise a polymeric binder.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, a gypsum panel formed in accordance with the present disclosure may be formed from a method as disclosed herein. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry and gypsum core is not necessarily limited and may be any generally known in the art. Generally, in one embodiment, the gypsum core is made from a gypsum slurry including at least stucco and water. However, as indicated herein, the gypsum slurry may include a water repellent composition. In this respect, the water repellent composition may be added to the gypsum slurry at any point in the process of forming the gypsum panel. Further, any optional additives as indicated herein may also be added to the gypsum slurry.

In general, stucco may be referred to as calcined gypsum or calcium sulfate hemihydrate. The calcined gypsum may be from a natural source, a synthetic source, or reclaim and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., All, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may include water. Water may be employed for fluidity and also for rehydration of the gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellents (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In one aspect, the foaming agent may include one or more foam stabilizers, such as ethoxylated glycerin. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less. Notably, the aforementioned values may be based on the gypsum core.

In some aspects, the gypsum slurry and/or gypsum core may include one or more dispersants. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less. Notably, the aforementioned values may be based on the gypsum core.

In some aspects, the gypsum slurry and/or gypsum core may include one or more surfactants. In general, the surfactant may be an anionic surfactant, a cationic surfactant, a non-ionic surfactant, a fluorinated surfactant, a silicon surfactant, or a mixture thereof. Generally, a surfactant may be in the form of a solid, a liquid, or a combination thereof.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate and/or olefin sulfonate (e.g., sodium olefin sulfonates, such as sodium C14-C16 olefin sulfonate, sodium C14-C18 olefin sulfonate, and sodium C16-C18 olefin sulfonate), and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in its molecular structure an alkyl group containing from about 8 to 22 carbon atoms and a sulfonate or sulfuric acid ester anionic group. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. In one aspect, the anionic surfactant may include C₆-C₁₂ linear and/or branched alkyl sulfates and/or C₆-C₁₂ linear and/or branched alkyl ether sulfates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In one aspect, the nonionic surfactant may be an amine oxide. In one aspect, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glyercol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In some aspects, a surfactant may include an ethoxylated alcohol that may include carbon chain lengths ranging from 12 to 20 carbon atoms. For instance, an ethoxylated alcohol may include carbon chain lengths ranging from 12 to 20 carbon atoms. A surfactant may include a blend of ethoxylated alcohols that have carbon chain lengths ranging from 12 to 20 carbon atoms. For instance, surfactant may include a blend of ethoxylated alcohols having carbon chain lengths ranging from 12 to 20 carbon atoms.

In one embodiment, the surfactant may include a cationic surfactant. For instance, the surfactant may include a cationic surfactant such as water-soluble quaternary ammonium compounds, polyammonium salts, a polyoxyethylene alkylamine and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

In some aspects, the gypsum slurry and/or gypsum core may include one or more starches. The starch may be one generally utilized in the art. Such starch may be combined with the stucco and water. In this regard, such starch may be present in the gypsum slurry as well as the resulting gypsum core and gypsum panel. In one aspect, one or more components of a gypsum panel may be free of starch. For instance, the gypsum core and/or gypsum slurry may be free of starch. In one aspect, a gypsum panel formed in accordance with the present disclosure may be free of starch.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, oxidation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components of the gypsum slurry are combined is not necessarily limited. For instance, the gypsum slurry can be made using any method or device generally known in the art. In particular, the components of the gypsum slurry can be mixed or combined using any method or device generally known in the art. The components of the gypsum slurry may be combined in any type of device, such as a mixer and in particular a pin mixer or pinless mixer. In this regard, the manner in which the components are incorporated into the gypsum slurry is not necessarily limited by the present disclosure. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soaps may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, and as previously disclosed, the calcium sulfate hemihydrate of the stucco may react with the water to hydrate the calcium sulfate hemihydrate into calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for dewatering of the gypsum slurry, in particular dewatering any free water instead of combined water of the gypsum slurry. Thereafter, the method may also comprise a step of cutting a continuous gypsum sheet into a gypsum panel. Then, after the cutting step, the method may comprise a step of supplying the gypsum panel to a heating or drying device. For instance, such a heating or drying device may be a kiln and may allow for removal (e.g., evaporation) of any free water. The temperature and time required for drying in such heating device are not necessarily limited by the present disclosure.

In one embodiment, the gypsum core may include a first gypsum core layer and a second gypsum core layer. The first gypsum core layer may be between the first facing material (e.g., front of the panel) and the second gypsum core layer. In addition, the first gypsum core layer may have a density greater than the second gypsum core layer. Accordingly, the first gypsum core layer may be formed using a gypsum slurry without the use of a foaming agent and/or foam or with a reduced amount of foaming agent and/or foam, which may be utilized in forming the second gypsum core layer. In this regard, in one embodiment, the first gypsum core layer may have the same composition as the second gypsum core layer except that the second gypsum core layer may be formed using a foaming agent and/or foam or a greater amount of foaming agent and/or foam.

In one embodiment, the gypsum core may also include a third gypsum core layer. The third gypsum core layer may be provided between the second gypsum core layer and a second facing material (e.g., back of the panel). In one aspect, the third gypsum core layer may be located adjacent to the second facing material. Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of a foaming agent and/or foam or with a reduced amount of foaming agent and/or foam, which may be utilized in forming the second gypsum core layer. In this regard, in one embodiment, the third gypsum core layer may have the same composition as the second gypsum core layer except that the second gypsum core layer may be formed using a foaming agent and/or foam or a greater amount of foaming agent and/or foam.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include a foaming agent and/or foam or more foaming agent and/or foam than the first gypsum slurry. In this regard, in one embodiment, the first gypsum slurry may not include a foaming agent and/or foam. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include a foaming agent and/or foam or more foaming agent and/or foam than the third gypsum slurry. In this regard, in one embodiment, the third gypsum slurry may not include a foaming agent and/or foam. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Regardless of the above, any of the additives disclosed herein may be present in any combination of gypsum core layers. In one aspect, one or more gypsum core layers may comprise the same additive or additives. Further, in one aspect, the one or more gypsum core layers may comprise different additives. The different additives of the one or more gypsum core layers may be chosen such that it is advantageous to have a particular additive in one gypsum core layer and a different additive in another, different gypsum core layer.

The gypsum panel disclosed herein may have many applications. For instance, the gypsum panel may be used as a standalone panel in construction for the preparation of walls, ceilings, floors, roofs, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 90 microns to about 1500 microns, such as about 90 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more. Generally, the average void size may be about 1,500 microns or less, such as about 1,300 microns or less, such as about 1,100 microns or less, such as about 1,000 microns or less, such as about 900 microns or less, such as about 800 microns or less, such as about 700 microns or less, such as about 600 microns or less, such as about 500 microns or less, such as about 400 microns or less, such as about 300 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 5 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more. The specific surface area of the gypsum core may be 5 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, the thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present disclosure is not necessarily limited by the aforementioned thicknesses.

In addition, the panel weight of the gypsum panel is not necessarily limited. The gypsum panel may have a panel weight of about 500 lbs/MSF to about 7000 lbs/MSF, including all increments of 1 lb/MSF therebetween. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2100 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight, such as after the panel leaves the heating or drying device (e.g., kiln).

In general, the calcination of a gypsum panel may be determined, at least in part, by the weight percent of calcium sulfate hemihydrate. The calcination of a gypsum panel may be determined by X-ray diffraction (XRD) analysis, such as with a PANalytical X'Pert Pro or Olympus BTX diffractometer, of a sample of the gypsum core or respective gypsum core layer scraped from a portion of a respective facing material adjacent the gypsum core or respective gypsum core layer. In this respect, when a respective facing material is removed from the gypsum core, the side of the facing material that was previously adjacent the gypsum core may be scraped to obtain a sample of the gypsum core or respective gypsum core layer.

In some aspects, a gypsum panel formed in accordance with the present disclosure may have a calcium sulfate hemihydrate content of about 0.01 wt. % to about 15 wt. %, including all increments of 0.01 wt. % therebetween, such as about 0.01 wt. % or more, such as about 0.05 wt. % or more, such as about 0.1 wt. % or more, such as about 0.2 wt. % or more, such as about 0.5 wt. % or more, such as about 0.8 wt. % or more, such as about 0.9 wt. % or more, such as about 1 wt. % or more, such as about 1.2 wt. % or more, such as about 1.5 wt. % or more, such as about 2 wt. % or more, such as about 3 wt. % or more, such as about 4 wt. % or more, such as about 5 wt. % or more, such as about 10 wt. % or more. Generally, the calcium sulfate hemihydrate content of the gypsum panel may be less than about 15 wt. %, such as about 10 wt. % or less, such as about 8 wt. % or less, such as about 5 wt. % or less, such as about 4 wt. % or less, such as about 3 wt. % or less, such as about 2 wt. % or less, such as about 1.5 wt. % or less, such as about 1 wt. % or less, such as about 0.9 wt. % or less, such as about 0.8 wt. % or less, such as about 0.5 wt. % or less, such as about 0.2 wt. % or less, such as about 0.1 wt. % or less. The calcium sulfate hemihydrate content of a gypsum panel may be determined by X-ray diffraction (XRD) analysis, such as with a PANalytical X'Pert Pro or Olympus BTX diffractometer, of a sample of the gypsum core or respective gypsum core layer scraped from a portion of a respective facing material adjacent the gypsum core or respective gypsum core layer.

Generally, a gypsum panel formed in accordance with the present disclosure may have a calcium sulfate dihydrate content of about 70 wt. % to about 98 wt. %, including all increments of 0.01 wt. % therebetween, such as about 70 wt. % or more, such as about 75 wt. % or more, such as about 80 wt. % or more, such as about 85 wt. % or more, such as about 87 wt. % or more, such as about 90 wt. % or more, such as about 92 wt. % or more, such as about 95 wt. % or more. Generally, the calcium sulfate dihydrate content of the gypsum panel is less than about 98 wt. %, such as about 95 wt. % or less, such as about 92 wt. % or less, such as about 90 wt. % or less, such as about 87 wt. % or less, such as about 85 wt. % or less, such as about 80 wt. % or less, such as about 75 wt. % or less. The calcium sulfate dihydrate content of a gypsum panel may be determined by X-ray diffraction (XRD) analysis, such as with a PANalytical X'Pert Pro or Olympus BTX diffractometer, of a sample of the gypsum core or respective gypsum core layer scraped from a portion of a respective facing material adjacent the gypsum core or respective gypsum core layer.

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lbf, such as at least about 30 pounds, such as at least about 35 lbf, such as at least about 40 lbf, such as at least about 45 lbf, such as at least about 50 lbf, such as at least about 55 lbf, such as at least about 60 lbf, such as at least about 65 lbf, such as at least about 70 lbf, such as at least about 75 lbf, such as at least about 77 lbf, such as at least about 80 lbf, such as at least about 85 lbf, such as at least about 90 lbf, such as at least about 95 lbf, such as at least about 100 lbf as tested according to ASTM C1396-17. The nail pull resistance may be about 400 lbf or less, such as about 300 lbf or less, such as about 200 lbf or less, such as about 150 lbf or less, such as about 140 lbf or less, such as about 130 lbf or less, such as about 120 lbf or less, such as about 110 lbf or less, such as about 105 lbf or less, such as about 100 lbf or less, such as about 95 lbf or less, such as about 90 lbf or less, such as about 85 lbf or less, such as about 80 lbf or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lbf, such as at least about 10 lbf, such as at least about 11 lbf, such as at least about 12 lbf, such as at least about 15 lbf, such as at least about 18 lbf, such as at least about 20 lbf as tested according to ASTM C1396-17. The gypsum panel may have a core hardness of 50 lbf or less, such as about 40 lbf or less, such as about 35 lbf or less, such as about 30 lbf or less, such as about 25 lbf or less, such as about 20 lbf or less, such as about 18 lbf or less, such as about 15 lbf or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lbf, such as at least about 10 lbf, such as at least about 11 lbf, such as at least about 12 lbf, such as at least about 15 lbf, such as at least about 18 lbf, such as at least about 20 lbf, such as at least about 24 lbf, such as at least about 28 lbf, such as at least about 30 lbf, such as at least about 33 lbf as tested according to ASTM C1396-17 and ASTM C473-19. The gypsum panel may have an edge hardness of about 50 lbf or less, such as about 40 lbf or less, such as about 35 lbf or less, such as about 30 lb_{f} or less, such as about 25 lb_{f} or less, such as about 20 lbf or less, such as about 18 lbf or less, such as about 15 lbf or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

### Example 1

Gypsum core samples containing a water repellent additive were formed in accordance with the present disclosure. The gypsum core samples were tested for their respective two-hour water absorption at different shear rates. Notably, the water repellent additive was a methyl hydrogen siloxane fluid. For each gypsum core sample, three grams of a methyl hydrogen siloxane fluid was combined with 100 grams of water and sheared for a period of about 30 seconds. Next, the sheared mixture was added to a mixture of 870 grams of stucco, 2 grams of ball milled gypsum, 40 grams of foam water, and 720 grams of water and mixed for 11 seconds. Seven gypsum core samples were formed in accordance with ASTM C1396-17 from their respective mixture, and the two-hour water absorption values were determined in accordance with ASTM C1396-17 for the seven samples. Notably, the shearing of the methyl hydrogen siloxane fluid and the water of each mixture was performed at a different shear rate.

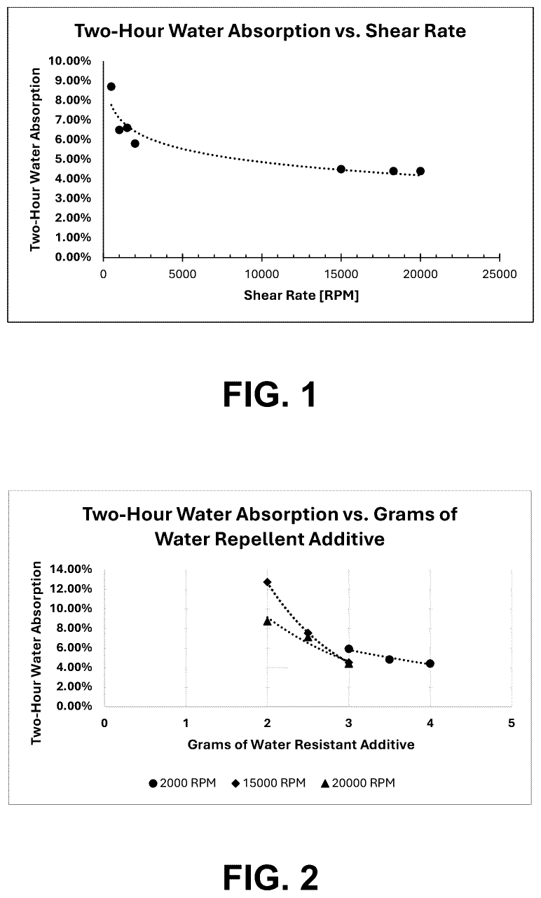

The two-hour water absorption values for the seven samples sheared at different shear rates are illustrated in Table 1 and FIG. 1. Notably, “RPM” stands for rotations per minute. FIG. 1 further illustrates a logarithmic trendline.

TABLE 1

| Sample | | Two-Hour Water |
|---|---|---|
| Number | RPM | Absorption [%] |
| 1 | 500 | 8.7 |
| 2 | 1000 | 6.5 |
| 3 | 1500 | 6.6 |
| 4 | 2000 | 5.8 |
| 5 | 15000 | 4.5 |
| 6 | 18300 | 4.4 |
| 7 | 20000 | 4.4 |

As observed in Table 1 and FIG. 1, the repellency of the gypsum core samples was enhanced as the RPM applied to the mixture of the methyl hydrogen siloxane fluid and the water was increased.

### Example 2

Gypsum core samples containing a water repellent additive were formed in accordance with the present disclosure. The gypsum core samples were tested for their respective two-hour water absorption at various shear rates. Notably, the water repellent additive was a methyl hydrogen siloxane fluid. For each gypsum core sample, a methyl hydrogen siloxane fluid was combined with 100 grams of water and sheared for a period of about 30 seconds. The grams of methyl hydrogen siloxane fluid utilized are illustrated in Table 2. Next, the sheared mixture was added to a mixture of 870 grams of stucco, 2 grams of ball milled gypsum, 40 grams of foam water, and 720 grams of water and mixed for 11 seconds. Nine gypsum core samples were formed in accordance with ASTM C1396-17 from their respective mixture, and the two-hour water absorption values were determined in accordance with ASTM C1396-17 for the nine samples. Notably, the shearing of the methyl hydrogen siloxane fluid and the water of the mixtures was performed at various shear rates.

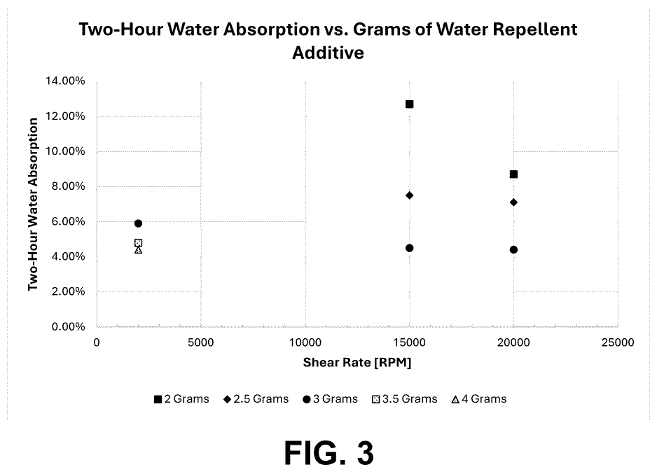

The two-hour water absorption values for the nine samples sheared at different shear rates are illustrated in Table 2 and FIG. 2. Notably, “RPM” stands for rotations per minute. FIG. 2 further illustrates three exponential trendlines. Additionally, FIG. 3 illustrates the two-hour water absorption values for the nine samples sheared at different shear rates.

TABLE 2

| | Amount of Methyl | | |
|---|---|---|---|
| | Hydrogen | | Two-Hour Water |
| Sample | Siloxane Fluid | | Absorption |
| Number | [grams] | RPM | [%] |
| 8 | 3.0 | 2000 | 5.9 |
| 9 | 3.5 | 2000 | 4.8 |
| 10 | 4.0 | 2000 | 4.4 |
| 11 | 2.0 | 15000 | 12.7 |
| 12 | 2.5 | 15000 | 7.5 |
| 13 | 3.0 | 15000 | 4.5 |
| 14 | 2.0 | 20000 | 8.7 |
| 15 | 2.5 | 20000 | 7.1 |
| 17 | 3.0 | 20000 | 4.4 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core, the gypsum core comprising gypsum;
a water repellent composition, the water repellent composition comprising a water repellent additive, the water repellent additive comprising a siloxane, the water repellent additive having been subjected to a shear rate of about 5,000 rpm or more; and
a first facing material and a second facing material;
wherein the gypsum core has a concentration gradient of the water repellent additive over a portion of the thickness of the gypsum core.

2. The gypsum panel of claim 1, wherein the water repellent additive has been subjected to a shear rate of 7,500 rpm or more.

3. The gypsum panel of claim 1, wherein the water repellent additive has been subjected to a shear rate of 8,500 rpm or more.

4. The gypsum panel of claim 1, wherein the water repellent additive has been subjected to a shear rate of 10,000 rpm or more.

5. The gypsum panel of claim 1, wherein the water repellent additive has been subjected to a shear rate of 12,000 rpm or more.

6. The gypsum panel of claim 1, wherein the water repellent additive is present in the gypsum panel in an amount from about 0.001 lbs/MSF to about 50 lbs/MSF.

7. The gypsum panel of claim 1, wherein the concentration of the water repellent additive decreases across a portion of the thickness of the gypsum core beginning at the portion of the gypsum core adjacent at least one facing material.

8. The gypsum panel of claim 1, wherein the concentration of the water repellent additive decreases across a portion of the thickness of the gypsum core beginning at the portion of the gypsum core adjacent the first facing material.

9. The gypsum panel of claim 1, wherein the water repellent additive has a viscosity of about 1 cSt to about 100 cSt before being subjected to shearing.

10. The gypsum panel of claim 1, wherein the water repellent composition comprises water.

11. The gypsum panel of claim 1, wherein the gypsum panel comprises a first gypsum core layer and a second gypsum core layer, wherein the first gypsum core layer, the second gypsum core layer, or both comprise the water repellent composition.

12. The gypsum panel of claim 1, wherein the water repellent composition is applied to at least a portion of a surface of the first facing material, the second facing material, or both.

13. The gypsum panel of claim 1, wherein:
the water repellent additive has been subjected to a shear rate of 8,500 rpm or more;
the water repellent additive is present in the gypsum panel in an amount from about 0.001 lbs/MSF to about 50 lbs/MSF; and
the concentration of the water repellent additive decreases across a portion of the thickness of the gypsum core beginning at the portion of the gypsum core adjacent the first facing material.

14. A gypsum panel comprising:
a gypsum core, the gypsum core comprising gypsum;
a water repellent composition, the water repellent composition comprising a water repellent additive, the water repellent additive comprising a siloxane, the gypsum core having a two-hour absorption of water of about 5% or less when tested in accordance with ASTM C1396-17; and
a first facing material and a second facing material;
wherein the gypsum core has a concentration gradient of the water repellent additive over a portion of the thickness of the gypsum core.

15. The gypsum panel of claim 14, wherein the water repellent additive has been subjected to a shear rate of 8,500 rpm or more.

16. The gypsum panel of claim 14, wherein the gypsum panel comprises a first gypsum core layer and a second gypsum core layer, wherein the first gypsum core layer, the second gypsum core layer, or both comprise the water repellent composition.

17. The gypsum panel of claim 14, wherein the water repellent composition is applied to at least a portion of a surface of the first facing material, the second facing material, or both.

18. The gypsum panel of claim 14, wherein:
the water repellent additive has been subjected to a shear rate of 8,500 rpm or more;
the water repellent additive is present in the gypsum panel in an amount from about 0.001 lbs/MSF to about 50 lbs/MSF; and
the concentration of the water repellent additive decreases across a portion of the thickness of the gypsum core beginning at the portion of the gypsum core adjacent the first facing material.

19. A method for making a gypsum panel comprising:
providing a first facing material;
depositing a gypsum slurry comprising stucco and water onto the first facing material, the gypsum slurry forming a gypsum core;
providing a second facing material on the gypsum slurry; and
allowing the stucco to convert to calcium sulfate dihydrate;
wherein the gypsum panel comprises a water repellent composition, the water repellent composition comprising a water repellent additive, the water repellent additive comprising a siloxane, the water repellent additive having been subjected to a shear rate of about 5,000 rpm or more.

20. The method of claim 19, wherein:
the gypsum core has a two-hour absorption of water of about 5% or less when tested in accordance with ASTM C1396-17;
the water repellent additive has been subjected to a shear rate of 8,500 rpm or more;
the water repellent additive is present in the gypsum panel in an amount from about 0.001 lbs/MSF to about 50 lbs/MSF; and
the concentration of the water repellent additive decreases across a portion of the thickness of the gypsum core beginning at the portion of the gypsum core adjacent the first facing material.
